(19) United States
(12) Patent Application Publication
(10) Pub. No.: US 2025/0246347 A1
(43) Pub. Date: Jul. 31, 2025

(54) METHOD FOR PREPARING NEODYMIUM IRON BORON MAGNET AND USE OF HYDROGEL

(71) Applicant: Baotou Research Institute of Rare Earths, Baotou City (CN)

(72) Inventors: Yan Gao, Baotou City (CN); Jianlong Fu, Baotou City (CN); Haiyang Yu, Baotou City (CN); Dongbo Wang, Baotou City (CN); Kai Qu, Baotou City (CN); Deying Zhu, Baotou City (CN); Yanwei Song, Baotou City (CN); Wenliang Xie, Baotou City (CN); Yu Wang, Baotou City (CN); Guozheng Liu, Baotou City (CN)

(21) Appl. No.: 18/894,843

(22) Filed: Sep. 24, 2024

(30) Foreign Application Priority Data
Jan. 31, 2024 (CN) 202410135833.2

(51) Int. Cl. H01F 1/057; B01J 13/00; H01F 41/02

(52) U.S. Cl. CPC H01F 1/0577; B01J 13/0065; H01F 41/0266; H01F 41/0293

(57) ABSTRACT

Provided are a method for preparing a neodymium iron boron (NdFeB) magnet and use of a hydrogel. The method includes: (1) providing a gel diffusion source including a heavy rare earth element powder and a hydrogel, where the hydrogel includes a water-absorbing substance and a dispersant, the water-absorbing substance is a cross-linked polymer, and a monomer forming the cross-linked polymer is one or more selected from the group consisting of acrylic acid, methacrylic acid, acrylamide, and hydroxyethyl methacrylate; (2) attaching the gel diffusion source to a surface of an NdFeB substrate to obtain a magnet attached with a hydrogel layer on a surface; and (3) subjecting the magnet attached with the hydrogel layer on the surface to a heat treatment to obtain the NdFeB magnet.

### CROSS REFERENCE TO RELATED APPLICATION

This patent application claims the benefit and priority of Chinese Patent Application No. 202410135833.2 filed with the China National Intellectual Property Administration on Jan. 31, 2024, the disclosure of which is incorporated by reference herein in its entirety as part of the present application.

### TECHNICAL FIELD

The present disclosure relates to a method for preparing a neodymium iron boron (NdFeB) magnet and use of a hydrogel.

### BACKGROUND

Neodymium iron boron (NdFeB) magnets have excellent comprehensive properties and are widely used in fields of home appliances, wind power generation, and new energy vehicles. However, the NdFeB magnets also show low Curie temperature and poor temperature stability, and cannot meet the requirements for high-temperature operation. At present, a method for improving the coercivity of NdFeB magnets is mainly to add heavy rare earth elements and transition elements to the NdFeB magnets to increase their coercivity and Curie temperature, which could increase the working temperature of the magnets to meet the application requirements. However, the method still has some disadvantages. For example, heavy rare earth elements can form antimagnetic coupling with iron, which may increase the coercivity while leading to a decrease in remanence and magnetic energy product. In addition, heavy rare earth elements are expensive, making large-scale production costly.

Grain boundary diffusion of heavy rare earth refers to a process in which heavy rare earth elements attached to the surface of sintered NdFeB magnets are diffused into the interior of the NdFeB magnets along the molten grain boundaries through a heat treatment, and can make intensive use of rare earth elements. Chinese publication No. CN116580958A discloses a method for improving properties of a sintered NdFeB magnet, comprising using Pr₈₀Al₂₀ and DyF₃ as diffusion sources and mixing with anhydrous ethanol to obtain a permeate. Chinese publication No. CN113380528A discloses a method for reshaping a grain boundary of a sintered NdFeB magnet, comprising preparing a heavy rare earth alloy into a powder, mixing with an organic glue, then evenly coating a resulting material onto an intermediate, and conducing grain boundary diffusion. Chinese publication No. CN117012537A discloses a method for preparing a high-temperature NdFeB permanent magnet by grain boundary diffusion, comprising mixing a powder containing heavy rare earth and cobalt with a glue and a diluent, then coating a resulting mixture onto a surface of the NdFeB magnet, and conducting high-temperature diffusion. Chinese publication No. CN104681225A discloses a treatment method for improving properties of a sintered NdFeB material, comprising dissolving one or a mixture of two or more of a rare earth oxide or fluoride containing Dy, Tb, and Ho elements, an Al powder, and metal Ga in a certain inorganic solvent to obtain a dispersion, where in order to enhance adhesion of the inorganic solvent, a certain thickener is added into the inorganic solvent; immersing a magnet in the dispersion, then taking out and conducting tempering. The above methods have little effect on improving the magnetic properties of NdFeB magnets.

### SUMMARY

In view of this, an object of the present disclosure is to provide a method for preparing an NdFeB magnet, which allows for improving the coercivity of the NdFeB magnet. Furthermore, the method has little effect on the remanence, maximum magnetic energy product, and squareness of the NdFeB magnet. Another object of the present disclosure is to provide use of a hydrogel.

In a first aspect, the present disclosure provides a method for preparing an NdFeB magnet, including the following steps:
(1) providing a gel diffusion source including a heavy rare earth element powder and a hydrogel; where the hydrogel includes a water-absorbing substance and a dispersant, the water-absorbing substance is a cross-linked polymer, and a monomer forming the cross-linked polymer is one or more selected from the group consisting of acrylic acid, methacrylic acid, acrylamide, and hydroxyethyl methacrylate;
(2) attaching the gel diffusion source to a surface of an NdFeB substrate to obtain a magnet attached with a hydrogel layer on a surface; and
(3) subjecting the magnet attached with the hydrogel layer on the surface to a heat treatment to obtain the NdFeB magnet.

In some embodiments, a cross-linking agent forming the cross-linked polymer does not contain other elements except carbon, hydrogen, oxygen, and nitrogen.

In some embodiments, the dispersant is one selected from the group consisting of water and an alcohol that is in a liquid form at a temperature of 20° C. to 35° C.

In some embodiments, the hydrogel is a carbomer hydrogel, and the dispersant is water.

In some embodiments, a weight ratio of the heavy rare earth element powder to the hydrogel is in a range of 1: (1-20).

In some embodiments, the heavy rare earth element powder is one selected from the group consisting of a heavy rare earth hydride powder, a heavy rare earth metal powder, and a heavy rare earth alloy powder, and
a heavy rare earth element in the heavy rare earth element powder is one selected from the group consisting of Dy and Tb.

In some embodiments, the heavy rare earth element powder has a surface mean diameter of 1.5 μm to 8 μm.

In some embodiments, the hydrogel layer has a thickness of 0.2 mm to 4 mm.

In some embodiments, the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

In a second aspect, the present disclosure provides use of a hydrogel in improving magnetic properties of an NdFeB magnet, where the hydrogel includes a water-absorbing substance and a dispersant,
the water-absorbing substance is a cross-linked polymer, and
a monomer forming the cross-linked polymer is one or more selected from the group consisting of acrylic acid, methacrylic acid, acrylamide, and hydroxyethyl methacrylate.

In the present disclosure, the method allows for improving magnetic properties of the NdFeB magnet. While improving coercivity, the method can reduce the influence on the remanence, maximum magnetic energy product, and squareness of the NdFeB magnet.

### DETAILED DESCRIPTION OF THE EMBODIMENTS

The present disclosure will be further described below in conjunction with specific embodiments, but the scope of the present disclosure is not limited thereto.

### Preparation Method of NdFeB Magnet

In the present disclosure, provided is a method for preparing an NdFeB magnet, including the following steps: (1) providing a gel diffusion source; (2) obtaining a magnet attached with a hydrogel layer on a surface; and (3) obtaining the NdFeB magnet.

### Providing a Gel Diffusion Source

In the present disclosure, a gel diffusion source including a heavy rare earth element powder and a hydrogel is provided. In some embodiments, the gel diffusion source includes (or consists of) the heavy rare earth element powder and the hydrogel. It is found that dispersing the heavy rare earth element powder in a specific hydrogel can improve the grain boundary diffusion effect of the heavy rare earth element, reduce the influence of the solvent on the diffusion effect, improve the intrinsic coercivity of the NdFeB magnet, and have little effect on parameters such as remanence, maximum magnetic energy product, and squareness.

In some embodiments of the present disclosure, the heavy rare earth element powder is one or more selected from the group consisting of a heavy rare earth hydride powder, a heavy rare earth metal powder, and a heavy rare earth alloy powder.

In some embodiments of the present disclosure, a heavy rare earth element in the heavy rare earth element powder is one selected from the group consisting of Dy and Tb.

Examples of the heavy rare earth hydride powder include but are not limited to terbium hydride and dysprosium hydride.

Examples of the heavy rare earth metal powder include but are not limited to metal terbium and metal dysprosium.

In some embodiments of the present disclosure, the heavy rare earth alloy powder is an alloy formed between heavy rare earth and heavy rare earth elements, or an alloy formed between heavy rare earth and iron. Examples of the heavy rare earth alloy powder include but are not limited to DyFe alloy, TbFe alloy, and Dy—Tb—Fe alloy.

In some embodiments of the present disclosure, a content of the heavy rare earth element in a heavy rare earth iron alloy is in a range of 60 wt % to 98 wt %, preferably 70 wt % to 95 wt %, and more preferably 80 wt % to 94 wt %.

In some embodiments of the present disclosure, a mass ratio of the Dy to the Tb in the Dy—Tb—Fe alloy is in a range of 35: (10-25), and preferably 35: (15-20).

In some embodiments of the present disclosure, the heavy rare earth element powder has a surface mean diameter (SMD) of 1.5 μm to 8 μm, preferably 2 μm to 7 μm. In some embodiments, the heavy rare earth element powder has a SMD of 4 μm to 6 μm. Such a surface mean diameter can prevent the heavy rare earth element powder from being oxidized and can evenly disperse the heavy rare earth element powder in the gel diffusion source.

In some embodiments of the present disclosure, a blocky heavy rare earth element material is formed into a powder by using a jaw crusher, a grinding mill, or a ball mill, or the powder is prepared by melting or physical crushing. In some embodiments of the present disclosure, when the grinding mill or ball mill is used for crushing, petroleum ether or anhydrous ethanol is used as a protective agent, and then a resulting powder is collected in a packaging belt, or vacuum-packaged or placed into an inert gas protection chamber.

In some embodiments of the present disclosure, the hydrogel includes a water-absorbing substance and a dispersant. The water-absorbing substance swells in the dispersant to form the hydrogel.

In some embodiments of the present disclosure, the water-absorbing substance is a cross-linked polymer. In some embodiments of the present disclosure, a monomer forming the cross-linked polymer is one or more selected from the group consisting of acrylic acid, methacrylic acid, acrylamide, and hydroxyethyl methacrylate. In some embodiments, the monomer forming the cross-linked polymer is one or more selected from the group consisting of acrylic acid and methacrylic acid.

In some embodiments of the present disclosure, a cross-linking agent forming the cross-linked polymer dose not contain other elements except carbon, hydrogen, oxygen, and nitrogen. In some embodiments of the present disclosure, the cross-linking agent has a functionality of 2 to 10. In some embodiments, the cross-linking agent has a functionality of 3 to 8. In other embodiments, the cross-linking agent has a functionality of 5 to 7. Examples of the cross-linking agent include but are not limited to allyl sucrose, pentaerythritol allyl ether, and pentaerythritol.

In some embodiments of the present disclosure, the dispersant is one selected from the group consisting of water and an alcohol that is in a liquid form at a temperature of 20° C. to 35° C. Examples of the alcohol include but are not limited to methanol, ethanol, propanol, and isopropanol. In some embodiments, the dispersant is water.

In some embodiments of the present disclosure, a content of the dispersant in the hydrogel is in a range of 70 wt % to 98 wt %, preferably 85 wt % to 95 wt %, and more preferably 90 wt % to 93 wt %.

In some embodiments of the present disclosure, the hydrogel is a carbomer hydrogel. In some embodiments, the carbomer hydrogel is formed from carbomer 940 and water.

In some embodiments of the present disclosure, a mass ratio of the heavy rare earth element powder to the hydrogel is in a range of 1: (1-20), preferably 1: (3-18). In some embodiments, the mass ratio of the heavy rare earth element powder to the hydrogel is in a range of 1: (4-12). This mass ratio enables the powder to be fully and evenly mixed with the hydrogel.

In some embodiments of the present disclosure, the heavy rare earth element powder and the hydrogel are mixed to obtain the gel diffusion source. In some embodiments, the heavy rare earth element powder and the hydrogel are mixed using a stirring device or manually. The stirring device is, for example, a digital display stirrer or an electric stirrer.

### Obtaining a Magnet Attached With a Hydrogel Layer on a Surface

In the present disclosure, the gel diffusion source is attached to a surface of an NdFeB substrate to obtain a magnet attached with a hydrogel layer on a surface.

In some embodiments of the present disclosure, the gel diffusion source is attached to the surface of the NdFeB substrate by coating.

In some embodiments of the present disclosure, the hydrogel layer has a thickness of 0.2 mm to 4 mm, preferably 0.5 mm to 3 mm, and more preferably 1 mm to 2 mm.

In some embodiments of the present disclosure, the NdFeB substrate is a sintered NdFeB substrate prepared by sintering.

In some embodiments of the present disclosure, the NdFeB substrate includes a rare earth element, Fe element, and B element. In some embodiments, the NdFeB substrate further includes one or more selected from the group consisting of Cu element, Al element, Co element, Ga element, Zr element, and Nb element. In some embodiments, the NdFeB substrate consists of only the above elements except inevitable impurities.

In some embodiments of the present disclosure, the rare earth element has a content of 28.5 wt % to 33 wt %. In some embodiments, the rare earth element has a content of 30 wt % to 32 wt %. In other embodiments, the rare earth element has a content of 30.5 wt % to 31 wt %.

In some embodiments of the present disclosure, the rare earth element must contain Nd. In some embodiments, the rare earth element further include one or more selected from the group consisting of Pr and Tb.

In some embodiments of the present disclosure, the Nd element has a content of 20 wt % to 27 wt %, preferably 22 wt % to 25 wt %. In some embodiments, the Nd element has a content of 22.8 wt % to 23.5 wt %.

In some embodiments of the present disclosure, the Pr has a content of 5.5 wt % to 9 wt %, preferably 6 wt % to 8 wt %. In some embodiments, the Pr has a content of 6.5 wt % to 7.1 wt %.

In some embodiments of the present disclosure, the Tb has a content of 1 wt % to 4 wt %, preferably 1.5 wt % to 3 wt %, and more preferably 2 wt % to 2.5 wt %.

In some embodiments of the present disclosure, the Fe element has a content of 63 wt % to 69 wt %, preferably 65 wt % to 68 wt %. In some embodiments, the Fe element has a content of 66 wt % to 67.5 wt %.

In some embodiments of the present disclosure, the B element has a content of 0.95 wt % to 1.05 wt %, and preferably 0.98 wt % to 1 wt %.

In some embodiments of the present disclosure, the Cu element has a content of 0.05 wt % to 0.4 wt %, preferably 0.1 wt % to 0.3 wt %, and more preferably 0.2 wt % to 0.25 wt %.

In some embodiments of the present disclosure, the Al element has a content of 0.3 wt % to 0.9 wt %, preferably 0.4 wt % to 0.7 wt %, and more preferably 0.5 wt % to 0.6 wt %.

In some embodiments of the present disclosure, the Co element has a content of 0.8 wt % to 1.6 wt %, preferably 1 wt % to 1.5 wt %, and more preferably 1.2 wt % to 1.3 wt %.

In some embodiments of the present disclosure, the Ga element has a content of 0.1 wt % to 0.5 wt %, and preferably 0.2 wt % to 0.4 wt %.

In some embodiments of the present disclosure, the Zr element has a content of 0.3 wt % to 1 wt %, preferably 0.5 wt % to 0.8 wt %, and more preferably 0.6 wt % to 0.7 wt %.

In some embodiments of the present disclosure, the Nb element has a content of 0.05 wt % to 0.4 wt %, preferably 0.1 wt % to 0.3 wt %, and more preferably 0.2 wt % to 0.25 wt %.

In some embodiments of the present disclosure, the NdFeB substrate has a composition as shown in one of the following:
Pr_{6.5}Nd_{22.8}Fe_{67.72}B_{0.98}Cu_{0.2}Al_{0.6}Co_{1.3};
Pr_{7.04}Nd_{24.96}Fe_{65.32}B_{0.98}Cu_{0.2}Al_{0.6}Ga_{0.3}Zr_{0.6};
Pr_{6.3}Nd₂₂Tb2.2Fe_{66.52}B_{0.98}Cu_{0.2}Al_{0.6}Ga_{0.3}Zr_{0.7}Nb_{0.2}; and
Pr_{6.3}Nd₂₂Tb1.7Fe_{67.02}B_{0.98}Cu_{0.2}Al_{0.6}Ga_{0.3}Zr_{0.7}Nb_{0.2}.

In some embodiments of the present disclosure, the NdFeB substrate is a surface-treated NdFeB substrate. In some embodiments, a surface of the NdFeB substrate is polished with sandpaper, and then oil stains on the surface are washed away. In some embodiments, the oil stains on the surface of the NdFeB substrate are washed away by using an alcohol. Examples of the alcohol include but are not limited to methanol, ethanol, and propanol.

### Obtaining the NdFeB Magnet

In the present disclosure, the magnet attached with the hydrogel layer on the surface is subjected to a heat treatment to obtain the NdFeB magnet.

In some embodiments of the present disclosure, the heat treatment is performed by: a first stage: holding the magnet at a temperature of T₁ for t₁ time; a second stage: holding at a temperature of T₂ for t₂ time; a third stage: cooling a product obtained in the second stage, and then tempering at a temperature of T₃ for t₃ time.

In some embodiments of the present disclosure, the T₁ is 100° C. to 220° C., preferably 110° C. to 200° C., and more preferably 120° C. to 150° C.

In some embodiments of the present disclosure, the t₁ is 0.5 h to 5 h, preferably 1 h to 4 h, and more preferably 2 h to 3 h.

In some embodiments of the present disclosure, the first stage is conducted at a pressure of less than 10⁻¹ Pa, and preferably less than 10⁻² Pa.

In some embodiments of the present disclosure, the first stage is conducted at a relatively low temperature, so as to prevent the dispersant in the hydrogel from reacting with the heavy rare earth element powder or the NdFeB substrate and then affect the magnetic properties of the NdFeB magnet.

In some embodiments of the present disclosure, the T₂ is 750° C. to 1,000° C., preferably 800° C. to 950° C., and more preferably 850° C. to 900° C.

In some embodiments of the present disclosure, the t₂ is 2 h to 16 h, and preferably 3 h to 15 h. In some embodiments, the t₂ is 5 h to 10 h.

In some embodiments of the present disclosure, the second stage is conducted at a pressure of less than 10⁻² Pa, and preferably less than 10⁻³ Pa.

In some embodiments of the present disclosure, the cooling in the third stage is conducted by air cooling.

In some embodiments of the present disclosure, the T₃ is 450° C. to 600° C., preferably 460° C. to 550° C., and more preferably 490° C. to 500° C.

In some embodiments of the present disclosure, the t₃ is 1 h to 8 h, preferably 2 h to 5 h, and more preferably 2 h to 3 h.

In some embodiments of the present disclosure, a cooling is also conducted after the heat treatment. In some embodiments, the cooling is conducted by air cooling.

### Use of a Hydrogel

It is found that dispersing the heavy rare earth element powder in a specific hydrogel allows for improving the grain boundary diffusion effect of the heavy rare earth element, reducing the influence of the solvent on the diffusion effect, improving the intrinsic coercivity of the NdFeB magnet, and having little effect on parameters such as remanence, maximum magnetic energy product, and squareness. Therefore, the present disclosure provides use of a hydrogel in improving a magnetic properties of the NdFeB magnet. The hydrogel is described above.

Specifically, the method includes the following steps: (1) providing a gel diffusion source including a heavy rare earth element powder and a hydrogel; (2) attaching the gel diffusion source to a surface of an NdFeB substrate to obtain a magnet attached with a hydrogel layer on a surface; and (3) subjecting the magnet attached with the hydrogel layer on the surface to a heat treatment to obtain the NdFeB magnet. Steps (1) to (3) are specifically described above and will not be repeated here.

The test methods used in the examples and comparative examples are described below:

Magnetic properties (including intrinsic coercivity, remanence, maximum magnetic energy product, and squareness): the magnetic properties were measured by using an ultra-high coercivity permanent magnet testing instrument.

The raw materials are as follows:

Carbomer was Carbomer 940 with a purity of 99.00%, purchased from Yien (Shanghai) Chemical Technology Co., Ltd, China.

A dispersant in the carbomer hydrogel was water, and a content of the dispersant was 92 wt %.

### Example 1

A carbomer hydrogel was mixed with a DyFe alloy powder to obtain a gel diffusion source. A mass ratio of the DyFe alloy powder to the carbomer hydrogel was 1:10. The DyFe alloy powder had a surface mean diameter of 2.58 μm. Dy in the DyFe alloy had a content of 80 wt %.

A sintered NdFeB substrate (ϕ12×2.5 mm) was polished clean with 240-mesh, 500-mesh, and 1000-mesh sandpapers in sequence, and oil stains on its surface were washed away with anhydrous ethanol to obtain a surface-treated sintered NdFeB substrate. The sintered NdFeB substrate had a chemical composition of Pr_{6.5}Nd_{22.8}Fe_{67.72}B_{0.98}Cu_{0.2}Al_{0.6}Co_{1.3}.

The gel diffusion source was coated onto a surface of the surface-treated sintered NdFeB substrate, a hydrogel layer with a thickness of 1 mm was formed on the surface of the sintered NdFeB substrate, to obtain a magnet attached with a hydrogel layer on a surface.

The magnet attached with the hydrogel layer on the surface was subjected to a heat treatment, and a resulting heat-treated magnet was air-cooled to obtain a NdFeB magnet. The heat treatment was performed by: holding the magnet for 2 h at a pressure of less than 10⁻² Pa and a temperature of 120° C.; holding for 3.5 h at a pressure of less than 10⁻³ Pa and a temperature of 900° C.; and after air cooling, tempering for 2.0 h at a pressure of less than 10⁻³ Pa and a temperature of 490° C.

The magnetic properties of the obtained NdFeB magnet are shown in Table 1.

### Comparative Example 1

A surface-treated sintered NdFeB substrate same as that in Example 1 was subjected to a heat treatment in the same manner as in Example 1 to obtain a NdFeB magnet. The steps were specifically as follows:

A sintered NdFeB substrate (ϕ12×2.5 mm) was polished clean with 240-mesh, 500-mesh, and 1000-mesh sandpapers in sequence, and oil stains on its surface were washed away with anhydrous ethanol to obtain the surface-treated sintered NdFeB substrate. The sintered NdFeB substrate had a chemical composition that was the same as that in Example 1.

The surface-treated sintered NdFeB substrate was subjected to the heat treatment, and a resulting heat-treated magnet was air-cooled to obtain the NdFeB magnet. The heat treatment was performed by: holding the NdFeB substrate for 2 h at a pressure of less than 10⁻² Pa and a temperature of 120° C.; holding for 3.5 h at a pressure of less than 10⁻³ Pa and a temperature of 900° C.; and after air cooling, tempering for 2.0 h at a pressure of less than 10⁻³ Pa and a temperature of 490° C.

The magnetic properties of the obtained NdFeB magnet are shown in Table 1.

TABLE 1

| | HcJ(kOe) | Br(T) | (BH)ₘₐₓ(MGOe) | Hk/HcJ(%) |
|---|---|---|---|---|
| Example 1 | 16.41 | 14.05 | 47.94 | 99.2 |
| Comparative | 12.04 | 14.02 | 47.65 | 94.0 |
| Example 1 | | | | |

### Example 2

A carbomer hydrogel was mixed with a Dy—Tb—Fe alloy powder to obtain a gel diffusion source. A mass ratio of the Dy—Tb—Fe alloy powder to the carbomer hydrogel was 1:10. The Dy—Tb—Fe alloy powder had a surface mean diameter of 5.6 μm. Dy and Tb in the Dy—Tb—Fe alloy powder had a total content of 94 wt %, wherein a mass ratio of the Dy to the Tb was 35:17.

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain a surface-treated sintered NdFeB substrate. The sintered NdFeB substrate had a chemical composition of Pr_{7.04}Nd_{24.96}Fe_{65.32}B_{0.98}Cu_{0.2}Al_{0.6}Ga_{0.3}Zr_{0.6}.

The gel diffusion source was coated onto a surface of the surface-treated sintered NdFeB substrate, a hydrogel layer with a thickness of 1 mm was formed on the surface of the sintered NdFeB substrate, to obtain a magnet attached with a hydrogel layer on a surface.

The magnet attached with the hydrogel layer on the surface was subjected to a heat treatment, and a resulting heat-treated magnet was air-cooled to obtain a NdFeB magnet. The heat treatment was performed by: holding the magnet for 2 h at a pressure of less than 10⁻² Pa and a temperature of 120° C.; holding for 5 h at a pressure of less than 10⁻³ Pa and a temperature of 900° C.; and after air cooling, tempering for 2.0 h at a pressure of less than 10⁻³ Pa and a temperature of 490° C.

The magnetic properties of the obtained NdFeB magnet are shown in Table 2.

### Comparative Example 2

A surface-treated sintered NdFeB substrate same as that in Example 2 was subjected to a heat treatment in the same manner as in Example 2 to obtain a NdFeB magnet. The steps were specifically as follows:

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain the surface-treated sintered NdFeB substrate. The sintered NdFeB substrate had a chemical composition that was the same as that in Example 2.

The surface-treated sintered NdFeB substrate was subjected to the heat treatment, and a resulting heat-treated magnet was air-cooled to obtain the NdFeB magnet. The heat treatment was performed by: holding the NdFeB substrate for 2 h at a pressure of less than 10⁻² Pa and a temperature of 120° C.; holding for 5 h at a pressure of less than 10⁻³ Pa and a temperature of 900° C.; and after air cooling, tempering for 2.0 h at a pressure of less than 10⁻³ Pa and a temperature of 490° C.

The magnetic properties of the obtained NdFeB magnet are shown in Table 2.

TABLE 2

| | HcJ(kOe) | Br(T) | (BH)ₘₐₓ(MGOe) | Hk/HcJ(%) |
|---|---|---|---|---|
| Example 2 | 16.46 | 1.28 | 40.61 | 93.9 |
| Comparative | 13.48 | 1.31 | 40.75 | 94 |
| Example 2 | | | | |

### Example 3

A carbomer hydrogel was mixed with a TbH₂ powder to obtain a gel diffusion source. A mass ratio of the TbH₂ powder to the carbomer hydrogel is 1:4. The TbH₂ powder had a surface mean diameter of 1.8 μm.

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain a surface-treated sintered NdFeB substrate. The sintered NdFeB substrate had a chemical composition of Pr_{6.3}Nd₂₂Tb2.2Fe_{66.52}B_{0.98}Cu_{0.2}Al_{0.6}Ga_{0.3}Zr_{0.7}Nb_{0.2}.

The gel diffusion source was coated onto a surface of the surface-treated sintered NdFeB substrate, a hydrogel layer with a thickness of 1 mm was formed on the surface of the sintered NdFeB substrate, to obtain a magnet attached with a hydrogel layer on a surface.

The magnet attached with the hydrogel layer on the surface was subjected to a heat treatment, and a resulting heat-treated magnet was air-cooled to obtain a NdFeB magnet. The heat treatment was performed by: holding for 2 h at a pressure of less than 10⁻² Pa and a temperature of 120° C.; holding for 7 h at a pressure of less than 10⁻³ Pa and a temperature of 900° C.; and after air cooling, tempering for 3.0 h at a pressure of less than 10⁻³ Pa and a temperature of 490° C.

The magnetic properties of the obtained NdFeB magnet are shown in Table 3.

### Comparative Example 3

A surface-treated sintered NdFeB substrate same as that in Example 3 was subjected to a heat treatment in the same manner as in Example 3 to obtain a NdFeB magnet. The steps were specifically as follows:

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain the surface-treated sintered NdFeB substrate. The sintered NdFeB substrate had a chemical composition that was the same as that in Example 3.

The surface-treated sintered NdFeB substrate was subjected to the heat treatment, and a resulting heat-treated magnet was air-cooled to obtain the NdFeB magnet. The heat treatment was performed by: holding the NdFeB substrate for 2 h at a pressure of less than 10⁻² Pa and a temperature of 120° C.; holding for 7 h at a pressure of less than 10⁻³ Pa and a temperature of 900° C.; and after air cooling, tempering for 3.0 h at a pressure of less than 10⁻³ Pa and a temperature of 490° C.

The magnetic properties of the obtained NdFeB magnet are shown in Table 3.

### Comparative Example 4

The process was the same as that in Example 3 except that the carbomer hydrogel was replaced with petroleum ether.

The magnetic properties of the obtained NdFeB magnet are shown in Table 3.

TABLE 3

| | HcJ(kOe) | Br(T) | (BH)ₘₐₓ(MGOe) | Hk/HcJ(%) |
|---|---|---|---|---|
| Example 3 | 31.73 | 13.55 | 44.94 | 90.8% |
| Comparative | 21.53 | 13.62 | 45.43 | 94.6% |
| Example 3 | | | | |
| Comparative | 31.77 | 13.33 | 43.61 | 87.5% |
| Example 4 | | | | |

### Example 4

A carbomer hydrogel was mixed with a TbH₂ powder to obtain a gel diffusion source. A mass ratio of the TbH₂ powder to the carbomer hydrogel was 1:5. The TbH₂ powder had a surface mean diameter of 1.8 μm.

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain a surface-treated sintered NdFeB substrate. The sintered NdFeB substrate had a chemical composition of Pr_{6.3}Nd₂₂Tb1.7Fe_{67.02}B_{0.98}Cu_{0.2}Al_{0.6}Ga_{0.3}Zr_{0.7}Nb_{0.2}.

The gel diffusion source was coated onto a surface of the surface-treated sintered NdFeB substrate, a hydrogel layer with a thickness of 1 mm was formed on the surface of the sintered NdFeB substrate, to obtain a magnet attached with a hydrogel layer on a surface.

The magnet attached with the hydrogel layer on the surface was subjected to a heat treatment, and a resulting heat-treated magnet was air-cooled to obtain a NdFeB magnet. The heat treatment was performed by: holding the magnet for 2 h at a pressure of less than 10⁻² Pa and a temperature of 120° C.; holding for 7 h at a pressure of less than 10⁻³ Pa and a temperature of 900° C.; and after air cooling, tempering for 3.0 h at a pressure of less than 10⁻³ Pa and a temperature of 490° C.

The magnetic properties of the obtained NdFeB magnet are shown in Table 4.

### Comparative Example 5

A surface-treated sintered NdFeB substrate same as that in Example 4 was subjected to a heat treatment in the same manner as in Example 4 to obtain a NdFeB magnet. The steps were specifically as follows:

A sintered NdFeB substrate (ϕ10×4.0 mm) was polished clean with 240-mesh, 500-mesh, and 1000-mesh sandpapers in sequence, and oil stains on its surface were washed away with anhydrous ethanol to obtain the surface-treated sintered NdFeB substrate. The sintered NdFeB substrate had a chemical composition that was the same as that in Example 4.

The surface-treated sintered NdFeB substrate was subjected to the heat treatment, and a resulting heat-treated magnet was air-cooled to obtain the NdFeB magnet. The heat treatment was performed by: holding the NdFeB substrate for 2 h at a pressure of less than 10⁻² Pa and a temperature of 120° C.; holding for 7 h at a pressure of less than 10⁻³ Pa and a temperature of 900° C.; and after air cooling, tempering for 3.0 h at a pressure of less than 10⁻³ Pa and a temperature of 490° C.

The magnetic properties of the obtained NdFeB magnet are shown in Table 4.

### Comparative Example 6

The process was the same as that in Example 4 except that the carbomer hydrogel was replaced with petroleum ether.

The magnetic properties of the obtained NdFeB magnet are shown in Table 4.

TABLE 4

| | HcJ(kOe) | Br(T) | (BH)ₘₐₓ(MGOe) | Hk/HcJ(%) |
|---|---|---|---|---|
| Example 4 | 27.08 | 14.11 | 48.57 | 90.9 |
| Comparative | 18.24 | 14.32 | 49.3 | 92.8 |
| Example 5 | | | | |
| Comparative | 25.6 | 14.12 | 48.73 | 88.6 |
| Example 6 | | | | |

The present disclosure is not limited to the above-mentioned embodiments. Without departing from the essence of the present disclosure, all variations, improvements, and substitutions conceivable by those skilled in the art fall within the scope of the present disclosure.

What is claimed is:

1. A method for preparing a neodymium iron boron (NdFeB) magnet, comprising the following steps:
(1) providing a gel diffusion source comprising a heavy rare earth element powder and a hydrogel, wherein the hydrogel comprises a water-absorbing substance and a dispersant, the water-absorbing substance is a cross-linked polymer, and a monomer forming the cross-linked polymer is one or more selected from the group consisting of acrylic acid, methacrylic acid, acrylamide, and hydroxyethyl methacrylate;
(2) attaching the gel diffusion source to a surface of an NdFeB substrate to obtain a magnet attached with a hydrogel layer on a surface; and
(3) subjecting the magnet attached with the hydrogel layer on the surface to a heat treatment to obtain the NdFeB magnet.

2. The method according to claim 1, wherein a cross-linking agent forming the cross-linked polymer does not contain other elements except carbon, hydrogen, oxygen, and nitrogen.

3. The method according to claim 1, wherein the dispersant is one selected from the group consisting of water and an alcohol that is in a liquid form at a temperature of 20° C. to 35° C.

4. The method according to claim 1, wherein the hydrogel is a carbomer hydrogel, and the dispersant is water.

5. The method according to claim 1, wherein a weight ratio of the heavy rare earth element powder to the hydrogel is in a range of 1: (1-20).

6. The method according to claim 1, wherein the heavy rare earth element powder is one selected from the group consisting of a heavy rare earth hydride powder, a heavy rare earth metal powder, and a heavy rare earth alloy powder, and
a heavy rare earth element in the heavy rare earth element powder is one selected from the group consisting of Dy and Tb.

7. The method according to claim 1, wherein the heavy rare earth element powder has a surface mean diameter of 1.5 μm to 8 μm.

8. The method according to claim 1, wherein the hydrogel layer has a thickness of 0.2 mm to 4 mm.

9. The method according to claim 1, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

10. A hydrogel, comprising a water-absorbing substance and a dispersant,
wherein the water-absorbing substance is a cross-linked polymer, and
a monomer forming the cross-linked polymer is one or more selected from the group consisting of acrylic acid, methacrylic acid, acrylamide, and hydroxyethyl methacrylate.

11. The method according to claim 2, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

12. The method according to claim 3, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

13. The method according to claim 4, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

14. The method according to claim 5, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

15. The method according to claim 6, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

16. The method according to claim 7, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.

17. The method according to claim 8, wherein the heat treatment is conducted by: holding the magnet at a first temperature of 100° C. to 220° C. for 0.5 h to 5 h, heating to a second temperature of 750° C. to 1,000° C. and holding at the second temperature for 2 h to 16 h, cooling, and tempering at a third temperature of 450° C. to 600° C. for 1 h to 8 h.
